(19) United States
(12) Patent Application Publication
(10) Pub. No.: US 2005/0014449 A1
(43) Pub. Date: Jan. 20, 2005

(54) Procedure for the fight against infestations in beehives

(76) Inventors: Mariano Higes Pascual, Madrid (ES); Montserrat De La Cruz Gomez, Guadalajara (ES); Angel Bonilla Munoz, Sant Boi De Llobregat (ES); Antonio Marca Fuig, La Garriga (ES); Joan Marca Puig, La Garriga (ES); Eva Navarrete Navarrette, Barcelona (ES); Jose Luis Bernal Yague, Valladolid (ES); Maria Jesus Del Nozal Nalda, Valladolid (ES)

Correspondence Address: SUGHRUE MION, PLLC, 2100 PENNSYLVANIA AVENUE, N.W., SUITE 800, WASHINGTON, DC, 20037, US

(21) Appl. No.: 10/498,217

(22) PCT Filed: Dec. 13, 2002
(86) PCT No.: PCT/EP02/14226

(30) Foreign Application Priority Data
Dec. 28, 2001 (ES) P 200102900

(51) Int. Cl. A01K 47/00

(52) U.S. Cl. 449/3

(57) ABSTRACT

A process for fighting infestation of honey producing bee colonies is described, especially varroosis, consisting of introducting into the beehives a composition with an aqueous, pasty character containing microcapsules of a polymeric coacervate which include microdroplets of essential oils, especially thymol. The process allows the beehive to be treated by only one introduction of the composition, assuring effective levels of essential oil in the atmosphere of the beehive during four to six weeks, all this without producing rejection effects in the bee colony.

The present invention refers to a procedure for the fight against infestations of melliferous bee colonies by the use of compounds that are capable of gradually and steadily releasing essential oils, preferable thymol, inside the beehives.

The melliferous bee colonies have a proclivity to suffer from infestations by organisms such as acarids, lepidoptera, fungi, bacteria, etc. that reduce the bees' health and, as a result, decrease the productivity of the apiculture exploitations. One of the main infestations suffered in the beehives is varroosis, caused by the acarid Varroa, which causes severe losses in apiculture.

For a long time it has been known that essential oils, and especially thymol, exert a potent effect against the infestation and the propagation of the infestation in beehives and specifically against varroosis. Within this context, we can mention: the Bulgarian patent BG10572, which describes a formulation to control the varroosis in bees and which contains thymol, propionic acid and glycerine; the Russian patent RU2145476, which describes the joint use of thymol and amitraz in the treatment of varroosis in bees; and the Russian patent RU2147177, which describes the use of compounds containing nistatine, thymol and a vegetable oil or vaseline to improve the efficacy in the control of ascopherosis in bees.

In a paper by Bruneau E., Abeilles & C^{ie} No. 71-72, 1999, pp 19-23, a review is made on the treatment with thymol of the bees' varroosis. This paper already indicates that the main problem for using thymol lies in achieving permanent levels of the essential oil in the atmosphere of the beehive. Thymol appears as crystals with low melting point and high vapour pressure and with a strong tendency to sublimate. Because of this, the direct introduction of thymol into the beehive produces excessively high thymol concentrations in the atmosphere, which are rejected by the bee colony and even results in the bees abandoning the beehive. On the other hand, the concentration decreases very quickly and, therefore, to maintain sufficient efficacy small quantities of thymol should be introduced into each beehive and constantly replaced every few days. This is very unproductive, because a normal apicultural exploitation consists of several thousands of beehives and the reproductive cycle of the Varroa can last between four and six weeks.

In the patent application WO97/47193 a solution is proposed for this problem, consisting of formulating the essential oil in gel type compositions which produce a retarded and sustained release of this essential oil.

The formulations described in WO97/47193 consist of gels, which comprise the essential oil in the form of a liquid composition and a gel-forming thickening component, amongst which carbomers such as CARBOPOL, carboxy-methyl-cellulose, hydrophilic polysaccharides, etc. can be mentioned. These gels are deposited on trays and introduced into the beehive, without needing replacement for several weeks.

However, the efficacy of the proposed gel formulations is quite reduced, as explained in the Table of Example 4 in the patent application WO97/47193. This Table indicates that the introduction into the beehive of one tray of the thymol formulation, in gel form, only allows a reduction of 48.3% of the infestation. Two trays should be introduced in order to achieve a reduction of more than 70% in the infestation levels. Furthermore, the proposed gel compositions are not very stable with regard to their physical form, and soon show a loss of consistency and exudation of aqueous solution.

So, the need persists to have more effective procedures available to control the infestations of the beehives, based on compounds with improved control of the release of essential oils, especially thymol, and which present a more stable and suitable physical form.

The object of the present invention is a procedure to fight against the infestations in melliferous bee colonies which consists of introducing into the beehives microencapsulated essential oil compounds which are able to release the essential oils in a controlled and sustained manner.

The procedure, object of the invention, consists of introducing into the beehive a compound, in the form of a consistent matrix of an aqueous nature, which is characterised by the fact that this compound contains the essential oil in microcapsules formed by a polymeric coacervate and by the fact that this compound includes, on the total compound weight:
(i) between 10% and 30% by weight of essential oil,
(ii) between 1% and 10% by weight of polymeric coacervate,
(iii) between 0,2% and 5% by weight of a non-ionic surfactant, the balance being water and other optional components.

Amongst the essential oils that are effective against the infestation of bee colonies we can mention monoterpenes, such as menthol, geraniol, myrcene, limonene, citral, camphor, etc., and more complex natural oils, such as lemon and eucalyptus oils, etc.

Different compositions containing microencapsulated essential oils are known, i.e. those described in the patent US6200572 or in a paper by Ribeiro A et al. J. Microencapsulation, 1997, Vol. 14, No. 6, 735-742. However, their use in fighting the infestation of bee colonies has not been described.

The especially preferred essential oil to be selected is thymol. Therefore, a composition characterised by containing thymol included as microcapsules formed by a polymeric coacervate, also constitutes part of the object of this invention. It is also part of the object of the invention that the composition contains the following:
(i) between 10% and 30% by weight of thymol,
(ii) between 1% and 10% by weight of polymeric coacervate,
(iii) between 0.2% and 5% by weight of a non-ionic surfactant, the balance being water and other optional components.

The polymeric coacervate can be formed by well-known techniques, such as polymer concentration, addition of inorganic salts, addition of incompatible polymers, polymer interaction, etc. In the book Drugs and the Pharmaceutical Sciences, Vol. 73: Microencapsulation Methods and Industrial Applications, Ed. Simon Benita, ISBN: 0-8247-9708-6, several methods to obtain microcapsules by coacervation are described.

To the effect of the present invention, the method based on polymer interaction is preferred.

Amongst the polymers suitable to form coacervates, the following can be mentioned: agar, albumin, collagen, gelatine, gum arabic, pectin, etc., as well as others of synthetic or semisynthetic origin, such as aliphatic polyesters, poylactic acid, policaprolactone, polyhydroxybutyrate, cellulose acetate, cellulose acetylphtalate, ethylcellulose, methylcellulose, hydroxypropylcellulose, carboxymethylcellulose, polyurethanes, polyamides, polyvinylalcohol, polyvinylpyrrolidone, etc.

The use of gelatine is preferred and, when using the polymer interaction method, the joint use of gelatine and carboxymethylcellulose, which is normally presented as its sodium salt, is especially preferred.

Gelatine is an ambiphilic protein, which can have a positive charge when the pH of the medium is below its isoelectric point or a negative charge when the pH of the medium is above this isoelectric point. For its part, carboxymethylcellulose is a polymer of the anionic polysaccharide type, with negative charge.

When the pH is adjusted below its isoelectric point, gelatine becomes positively charged and interacts with the anionic carboxymethylcellulose forming an insoluble coacervate.

If desired, or even preferred, this coacervate can be hardened and made more insoluble by treating the mixture with glutaraldehyde, which blocks the remaining reactive positions on the gelatine by forming Schiff's bases.

The non-ionic surfactant fulfils the function of maintaining and dispersing the thymol micro-droplets within the aqueous dispersion, favouring their inclusion in the microcapsules formed by the polymeric coacervate.

In principle, any type of non-ionic surfactant is useful, for instance: alkoxylated fatty alcohols, ethoxylated alkylphenols, saccharose or sorbitol esters eventually alkoxylated, etc., although the use of ethoxylated sorbitol esters, of the type known as TWEEN®, is preferred.

The pH adjustments can be made with any acid or alkali, organic or inorganic, provided it is not toxic for bees. The use of acetic acid and of triethanolamine as alkali is preferred.

Thickening or reticulating agents can also be optionally used to help the compositions of the invention to present a rheology suitable to their form of consistent, pasty masses and to favour their stability, preventing the formation of sediments and the appearance of liquid exudate during prolonged storage. From among the thickening agents, agar is preferred.

The compositions of the invention are prepared by well-known techniques, including the formation of an aqueous dispersion of the essential oil and the subsequent formation of microcapsules by polymeric coacervation following any of the aforesaid methods.

As already indicated, the procedure of the invention finds its most significant application in the control of varroosis and, to this effect, the compositions of the stated characteristics are introduced into the beehive and are maintained, without being renewed, for a period of between four and six weeks, which covers the reproductive cycle of Varroa. The mentioned compositions are capable of maintaining, during the said period, a stable concentration of thymol in the air of the beehive within the range of 0.600-0.700 μg/l, which are fully effective for eliminating the acarids from the beehive, but without creating an aggressive environment for the bees. This way, the results achieved are much more efficient than those described in the patent application WO97/47193, because the acaricide efficacy obtained with only one dose, expressed as percentage of dead varroas in respect to the total, achieves and surpasses 90%.

The compositions of the invention are consistent matrices, which adapt to the shape of the container. For use in beehives, trays with a shallow depth and a large surface area are preferred. These allow loading a dose of the product which is sufficient to assure the permanence of the thymol concentrations mentioned above in the beehive atmosphere during four to six weeks. This dose will depend on the thymol concentration in the composition. So, for a composition containing 15% thymol by weight, the dose can be between 170 and 230 g.

The examples below are presented with the aim of providing the expert in these matters with a sufficiently clear and comprehensive explanation of the present invention, but they should not be considered as limitations to the essential aspects of the invention, as has been expounded in former paragraphs of this description.

### EXAMPLES

### Example 1

### Preparation of a Composition According to the Invention, Using the Coacervation Method by the Addition of Inorganic Salts.

| | Quantity expressed in %, |
|---|---|
| | by weight, of the total weight |
| Ingredients | of the final composition. |
| Thymol | 15 |
| TWEEN ® 20 | 1 |
| Gelatine | 4 |
| Sodium sulphate (20% solution) | 6.25 |
| Sodium sulphate (7% solution) | 40 |
| Aqueous solution of gelatine at 20% | 10 |
| Purified water | Up to 100 |

Water is heated to 60° C. and gelatine is added, adjusting the pH to 6-6.5 with a few drops of 20% NaOH solution. This facilitates the dissolution process. In another container, thymol and TWEEN® 20 are weighed and heated to 60° C. until the thymol is totally molten. Then, the thymol dispersion is added on top of the aqueous gelatine solution, agitating while hot for 10 minutes to form the emulsion. The 20% sodium sulphate solution is added and, to enhance the coacervate formation, the 7% sodium sulphate solution, which has been previously chilled to 3° C., is added. Finally, maintaining the temperature at 40° C., the second gelatine solution is added and later the product is packed, cooled down and closed.

### Example 2

### Preparation of a Composition According to the Invention, Using the Coacervation Method of Polymer Concentration.

| | Quantity expressed in %, |
|---|---|
| | by weight, of the total weight |
| Ingredients | of the final composition. |
| Thymol | 15 |
| TWEEN ® 20 | 1 |
| Gelatine | 4.6 |
| Polyphosphate solution at 2% | To pH 4.4 |
| Glutaraldehyde (25% solution) | 0.4 |
| Aqueous solution of gelatine at 20% | 10 |
| Purified water | Up to 100 |

Water is heated to 60° C. and gelatine is added, adjusting the pH to 6-6.5 with a few drops of 20% NaOH solution. This facilitates the dissolution process. In separate container, thymol and TWEEN® 20 are weighed and heated to 60° C. until the thymol is totally molten. Then, the thymol dispersion is added on top of the aqueous gelatine solution, agitating while hot for 10 minutes to form the emulsion. The polyphosphate solution is slowly added until the pH reaches 4.4 and then the glutaraldehyde is added to harden the coacervate. Finally, maintaining the temperature at 40° C., the second gelatine solution is added and later the product is packed, cooled down and closed.

### Example 3

### Preparation of a Composition According to the Invention, Using the Coacervation Method of Incompatible Polymers.

| | Quantity expressed in %, |
|---|---|
| | by weight, of the total weight |
| Ingredients | of the final composition. |
| Thymol | 15 |
| TWEEN ® 20 | 1 |
| Sodium alginate | 0.5 |
| Hydroxypropylmethylcellulose | 0.5 |
| Calcium chloride (1% solution) | 25 |
| Aqueous solution of gelatine at 20% | 10 |
| Purified water | Up to 100 |

Water is heated at 60° C. and sodium alginate and hidroxypropylmethyl-cellulose are added, agitating until complete dissolution. In a separate container, thymol and TWEEN® 20 are weighed and heated to 60° C. until the thymol is totally molten. Then, the thymol dispersion is added on top of the aqueous sodium alginate and hidroxypropylmethyl-cellulose solution, agitating while hot for 10 minutes to form the emulsion. The calcium chloride solution is slowly added and, finally, maintaining the temperature at 40° C., the second gelatine solution is added and later the product is packed, cooled down and closed.

### Example 4

### Preparation of a Composition According to the Invention, Using the Coacervation Method of Incompatible Polymers.

| | Quantity expressed in %, |
|---|---|
| | by weight, of the total weight |
| Ingredients | of the final composition. |
| Thymol | 15 |
| TWEEN ® 20 | 2 |
| Albumin | 1 |
| Gum arabic | 1 |
| Hydrochloric acid 1 M | To pH 3.9 |
| Glutaraldehyde (25% solution) | 0.05 |
| Aqueous solution of gelatine at 20% | 10 |
| Purified water | Up to 100 |

Water is heated at 60° C. and albumin and gum arabic are added, agitating until complete dissolution. In a separate container, thymol and TWEEN® 20 are weighed and heated to 60° C. until the thymol is totally molten. Then, the thymol dispersion is added on top of the aqueous albumin and gum arabic solution, agitating while hot for 10 minutes to form the emulsion. The pH is adjusted to 3.9 with 1 M hydrochloric acid solution and later the glutaraldehyde is added to harden the coacervate. Finally, maintaining the temperature at 40° C., the second gelatine solution is added and later the product is packed, cooled down and closed.

### Example 5

### Preparation of a Composition According to the Invention, Using the Coacervation Method of Polymers Interaction.

| | Quantity expressed in %, |
|---|---|
| | by weight, of the total weight |
| Ingredients | of the final composition. |
| Thymol | 15 |
| TWEEN ® 20 | 1 |
| Gelatine | 2 |
| Carboxymethylcellulose (Na salt) | 1 |
| Triethanolamine | To pH 6.5 |
| Acetic acid | To pH 4.0 |
| Glutaraldehyde (25% solution) | 0.2 |
| Aqueous solution of gelatine at 20% | 10 |
| Agar | 0.4 |
| Purified water | Up to 100 |

Water is heated at 60° C. and gelatine and carboxymethylcellulose are added, agitating until complete solution. The pH is then adjusted to 6.5 by adding triethanolamine. In a separate container, thymol and TWEEN® 20 are weighed and heated to 60° C. until the thymol is totally molten. Then, the thymol dispersion is added on top of the aqueous gelatine and carboxymethylcellulose solution, agitating while hot for 10 minutes to form the emulsion. The pH is adjusted to 4.0 with acetic acid and later the glutaraldehyde is added to harden the coacervate. Finally, maintaining the temperature at 40° C., the 20% gelatine solution and the agar are added and later the product is packed, cooled down and closed.

### Example 6

### Biological Test

This test is carried out in the month of April with two groups of five beehives of melliferous bees each one. One of the groups is treated by introducing into the beehive one tray per beehive containing 200 g of the composition obtained in the example 5, while in the other, witness or control group, one tray per beehive is introduced, having the same composition but without containing thymol.

The parameters assessed were: 1) external and internal temperature; 2) thymol concentration in the atmosphere inside the beehive; 3) the bee mortality and 4) the acaricide efficacy.

Four controls were carried out: on day 7, on day 14, on day 21 and on day 28 days.

The varroas which have fallen during the test are collected in polyester trays located at the bottom of the beehive.

At the end of the test, the colonies were sacrificed using SO₂ and the number of bees of each colony and the sealed surface were counted. To verify the presence of acarids on adult bees, these were washed with hot water under pressure over a fine mesh screen. The sealed cells were opened and the existing larvae and pupae were extracted.

The observations carried out show the following:
The temperature variation oscillated between 13° C. and 26° C. inside the beehive (thymol evaporation zone) and between 7° C. and 16° C. outside. No influence of the temperature changes on the acaricide efficacy of the tested composition was observed.
The tested composition did not affect the activity and the viability of the colonies. The bee mortality is maintained constant and at normal levels.
The thymol concentration inside the beehive was constant with an average level in the order of 0.650 μg/l.
In the treated beehives, the average fall of varroas was 905 acarids, while in the control beehives it was 26.
After sacrificing the bees, the acarids count in the treated beehives presented a minimum of 4 acarids and a maximum of 61 acarids. The average in the control beehives was 600 acarids per beehive.
After the treatment, the thymol residues in honey were between 0.1 y 1 ppm, and in wax between 100 and 200 ppm. The said quantities disappeared after 45 days storage.

The acaricide efficacy of the tested composition, measured as the ratio between the acarids fallen during the entire test to the total number of acarids after sacrificing the beehive, showed an average value of 90.5% with a range of between 89.4% and 91.3%. These results were very homogeneous in all the cases tested.

1. A process for fighting an infestation of melliferous bees colonies consisting of introducing inside a beehive a composition in the form of a consistent paste, of aqueous nature, and which comprises an essential oil included in microcapsules formed by a polymeric coacervate and comprises, over the total composition weight:
(i) between 10% and 30% by weight of the essential oil,
(ii) between 1% and 10% by weight of polymeric coacervate,
(iii) between 0.2% and 5% by weight of a non-ionic surfactant.

2. The process according to claim 1, wherein the essential oil is thymol.

3. The process according to claims 1 or 2, wherein the polymeric coacervate is obtained from a polymer selected from the group consisting of albumin, collagen, gelatine, gum arabic, pectin, aliphatic polyesters, polylactic acid, polycaprolactone, polyhidroxybutyrate, cellulose acetate, cellulose acetylphtalate, ethylcellulose, methylcellulose, hidroxypropylcellulose, carboxymethylcellulose, polyurethanes, polyamides, polyvinylalcohol and polyvinylpyrrolidone, by the use of coacervation techniques consisting of polymer concentration, addition of inorganic salts, addition of incompatible polymers and polymer interaction.

4. The process according to claim 3, wherein the polymeric coacervate is obtained by the combined use of gelatine and carboxymethylcellulose, and applying the polymer interaction method.

5. The process according to claim 1, wherein the non-ionic surfactant is selected from the group consisting of an alkoxylated fatty alcohol, ethoxylated alkylphenol and saccharose or sorbitol esters, which can eventually be alkoxylated.

6. The process according to claim 5, wherein the non-ionic surfactant is a sorbitol ester, which can eventually be ethoxylated.

7. The process according to claim 1, wherein the composition contains a crosslinking agent.

8. The process according to claim 1, wherein the composition is introduced inside the beehive and is maintained, without renewal, for a period of between four and six weeks.

9. The process according to claim 2, wherein the thymol content of the composition is thymol concentrations in the air of the beehive of between 0.400 and 0.800 μg/l.

10. The process according to claim 1, wherein the infestation to be fought against is varroosis.

11. A composition for fighting infestation of bee colonies comprising thymol included in microcapsules formed by a polymeric coacervate and comprising, on the total weight of the composition:
(iv) between 10% and 30% by weight of thymol,
(v) between 1% and 10% by weight of polymeric coacervate,
(vi) between 0.2% and 5% by weight of non-ionic surfactant.

12. The composition according to claim 11, wherein the polymeric coacervate is obtained from a polymer selected from the group consisting of albumin, collagen, gelatine, gum arabic, pectin, aliphatic polyesters, polylactic acid, polycaprolactone, polyhydroxybutyrate, cellulose acetate, cellulose acetylphtalate, ethylcellulose, methylcellulose, hydroxypropylcellulose, carboxymethylcellulose, polyurethanes, polyamides, polyvinylalcohol and polyvinylpyrrolidone, by coacervation techniques consisting of polymer concentration, addition of inorganic salts, addition of incompatible polymers and polymer interaction.

13. The composition according to claim 12, wherein the polymeric coacervate is obtained by the joint use of gelatine and carboxymethylcellulose, and applying the polymer interaction method.

14. The composition according to claim 11, wherein the nonionic surfactant is selected from the group consisting of an alkoxylated fatty alcohol, ethoxylated alkylphenol and saccharose or sorbitol esters, which can eventually be alkoxylated.

15. The composition according to claim 14, wherein the non-ionic surfactant is a sorbitol ester, which can eventually be ethoxylated.

16. The composition according to claim 11, wherein the composition contains, in addition, a thickening agent.

17. The process according to claim 7, wherein the crosslinking agent is agar.

18. The composition according to claim 16, wherein the thickening agent is agar.
